(19) United States
(12) Patent Application Publication
(10) Pub. No.: US 2006/0218956 A1
(43) Pub. Date: Oct. 5, 2006

(54) Motor vehicle comprising an air conditioning system

(76) Inventors: Hans Hammer, Pfaffenhofen (DE); Dirk Schroeder, Baar-Ebenhausen (DE); Christian Rebinger, Ingolstadt (DE); Frank Obrist, Bregenz (AT); Frank Wolf, Hochst (AT); Martin Graz, Lustenau (AT)

Correspondence Address: LADAS & PARRY, 26 WEST 61ST STREET, NEW YORK, NY, 10023, US

(21) Appl. No.: 10/552,203

(22) PCT Filed: Apr. 8, 2004
(86) PCT No.: PCT/EP04/03790

§ 371 Date: Oct. 6, 2005

(30) Foreign Application Priority Data
Apr. 15, 2003 (DE) 103 17 184.3

(51) Int. Cl. B60H 1/32; F25D 19/00

(52) U.S. Cl. 62/296; 62/239; 62/298

(57) ABSTRACT

The aim of the invention is to obviate the need for rubber hoses or other flexible rubber compensation elements, which prevent the transmission of vibrations to the vehicle body. To achieve this, the pipelines of an air conditioning system including their pipe couplings (42-45) are configured entirely of metal with an external diameter, in relation to the compressor, of less than 11 mm on the discharge side and less than 13 mm on the suction side. A damping curvature (35, 36) is also configured in the pipelines (6′, 12′) that connect the compressor to a heat exchanger, in addition to at least one curvature (37-40) required by the installation geometry of the conduit system. The system is also equipped with a pipeline, designed to restrict the flow of operating fluid, said pipeline being configured as a particularly thin pipe with an internal diameter of capillary-tube type proportions, designed to restrict the flow and an external diameter ranging between 2 and 4 mm.

The invention relates to a motor vehicle with an air conditioning system, whose ducting connects a compressor, which is attached to the engine of the vehicle, with at least one heat exchanger, which is attached to the vehicle body, wherein the running ducting system in the engine compartment of the vehicle has a pipe curvature, which is dictated by the installation geometry in the vehicle space, at least one part of the pipe conduit is made of metallic substance and medium for damping of vibration is provided for avoiding transmission of vibrations from the compressor to the vehicle body.

The engine of a vehicle and the compressor of an air conditioning system, which is attached to it, are known to produce mechanical vibrations and pressure pulsations in flowing heat carriers (coolants) and the requirement is to prevent such vibrations from being transmitted to the body or the passenger cell of the vehicle through damping medium. The engine of the vehicle is placed for this purpose on damping bodies. Further, as per U.S. Pat. No. 5,367,883 for example, armoured rubber hoses are fitted in the pipe conduits of the ducting of the air conditioning system, said pipes leading from the compressor to a heat exchanger; thanks to their damping the pulsations through stretching radially and along the length, the transmission of vibration is prevented from the engine and the compressor to the heat exchangers, which are fixed on one side in the front area, and on the other side in the air conditioning box of the vehicle on the body and, thus, also to the body. Through their flexibility, the rubber hoses further make it easier to mount and de-mount the engine and also to lay the pipes of the ducting system in the engine compartment of the vehicle.

On account of the considerable pressure prevailing in the ducting system, armouring of rubber hoses and their leak-proof fitting in the otherwise metallic pipe conduits through a high-pressure tube connection at the end is, however, very cumbersome and hence costly. Besides, due to their larger diameters, rubber hoses demand additional space inside the engine compartment of the vehicle, making their installation more difficult. These rubber hoses further lead to a loss of the working medium since these cannot be made completely diffusion proof. These also cannot prevent the moisture in the ducting system from getting diffused, with the result that the lubricating properties of the lubricating oil, which is contained in the working medium are adversely affected. These disadvantages are also mentioned in U.S. Pat. No. 5,182,922. The application of flexible pipe connectors as alternatives, cannot, however, remove this deficiency completely due to the use of elastic sealing and jointing medium, which is subjected to shear forces and is also found wanting in high pressure zones as, for example, for air conditioning systems with CO 2 (carbon dioxide) as working medium.

It is the objective of the invention to avoid the above mentioned disadvantages and to find a suitable vehicle with an air-conditioning system, which, through less manufacturing costs and reduced space requirements, prevents transmission of vibrations to the heat exchanger of the air-conditioning system and consequently to the body of the vehicle.

As per the invention, the objective is fulfilled in such a manner that at least one pipe conduit, which, on one side, is connected to the compressor and, on the other, to a ducting's heat exchanger, which is attached to the vehicle body, is entirely made of metallic substance and has an outside diameter of less than 13 mm.

It was thus found that, in spite of using a very cost effective, integral, relatively rigid metallic substance for at least one of the pipe conduits of the ducting system and designing the same for high pressures, which are common for air conditioning systems, specially with carbon dioxide, an adequate yielding of the pipe conduits can be achieved to sufficiently dampen the vibrations being transmitted to an attached heat exchanger and therefore to the vehicle body. Due to its integral, relatively small diameter, for fitting of the pipe conduit, less space is required in the engine compartment on one hand and a flexibility, on the other, makes its installation in the engine compartment easier.

It is clear that the mentioned advantages become more prominent as the small pipe diameter as per the invention gets smaller. As per a preferred embodiment of the invention, a particularly thin pipe conduit with a capillary tube-like inside diameter of less than 2 mm and a length of, for example, 900 mm, corresponding with the installation geometry, can be provided in the area of the ducting of the air conditioning system, in which a throttling of flow of its working medium is intended in its function; with this, besides saving a throttle valve, a particularly high damping of vibrations results as well as the advantage of its simple installation in the engine compartment of the vehicle is obtained. This configuration is also particularly advantageous in applying the invention to a air conditioning system, which can be switched over to a so called ‘triangle process’ while heating up the vehicle, wherein a pipe conduit likewise leads straight from the compressor to a heat exchanger, which works to heat up the vehicle.

When the diameter of a fully metallic pipe conduit on the suction side, for example, is chosen in the above range as per the invention, the pipe's bendability can be lower than the more familiar rubber like hoses, in spite of its having adequate damping properties; through forcibly bending it by hand in freeing an assembly space while mounting or de-mounting the engine of the vehicle, it could get damaged. In this case, in a well accessible place in the engine compartment and away from the necessary connection couplings for the compressor and the heat exchanger, an additional, essentially cost effective pipe joint can be placed opposite a hose.

The integral form of the pipes, made of metal and preferably of an aluminium alloy, of the air conditioning system even leads to a poorer damping of pressure pulsations in the working medium flow of the air conditioning system; these can, however, be averted through an enlargement of cross section over a limited length in the air conditioning system in the form of, for example, a muffler soldered to a pipe. Such a thing can be manufactured in a cost effective way by deep drawing out of the same aluminium alloy, which is used for the pipes of the air conditioning system.

Further embodiments of the invention are described below with the help of drawings. It is shown in:

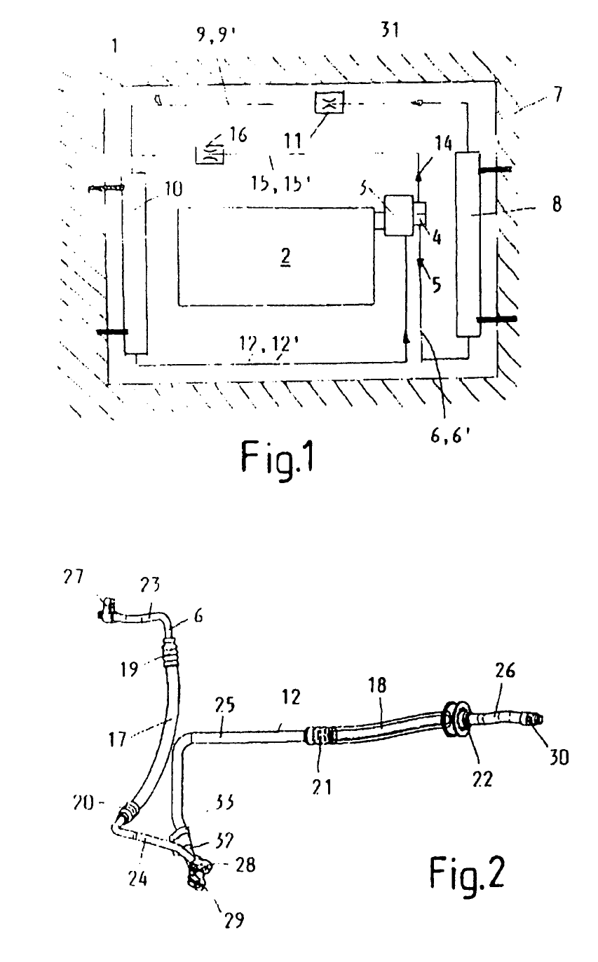

FIG. 1: A very simplified, schematic diagram of the ducting of an air conditioning system, which is arranged in the engine compartment of a vehicle.

FIG. 2: A perspective drawing of two pipe conduits of ducting of an air conditioning system as per the conventional technology.

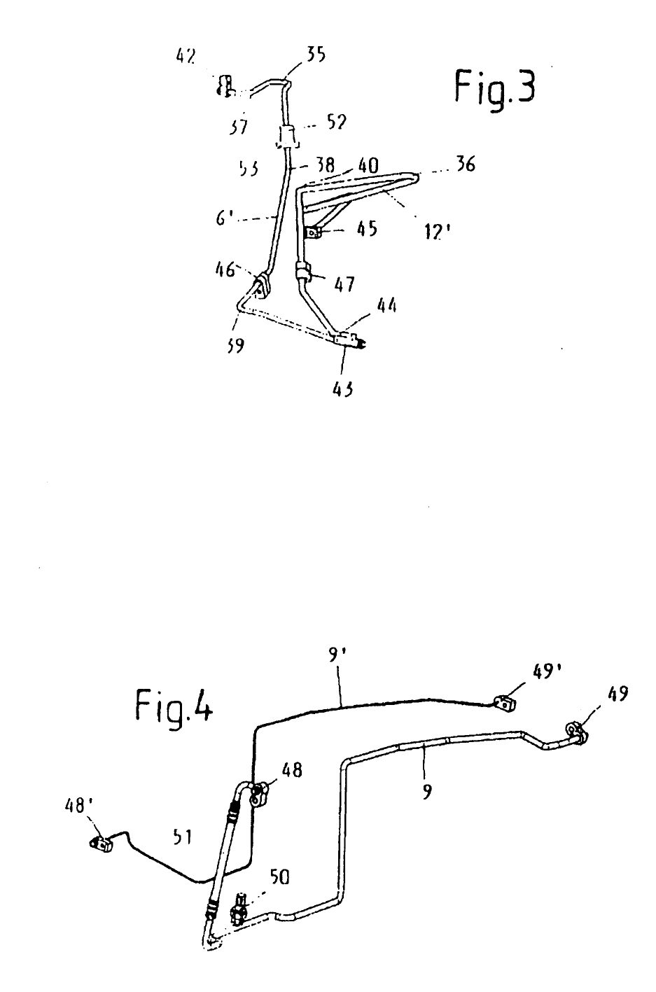

FIG. 3: A perspective drawing of two pipe conduits of ducting of an air conditioning system as per the invention. And

FIG. 4: A perspective drawing, comparing one pipe conduit each as per conventional technology and as per the invention.

The air conditioning system 1, which is shown in FIG. 1 and is suitable for cooling as well as heating, has conventionally a compressor 3, which is attached to the engine 2 of the motor vehicle. During the cooling operation, it delivers the working medium, which is preferably carbon dioxide (CO₂), via a switch valve 4 in the direction of the arrow 5 through a first pipe conduit 6 on the pressure side to a first heat exchanger 8, which is attached to the front side to the vehicle body 7. Through a second pipe conduit 9, it is connected to a second heat exchanger 10, which is attached to the vehicle body 7 and is placed, for example, in the climatic chamber of the vehicle. During working, expansion of the working medium takes place in this second pipe conduit 9, for which an expansion valve 11 is provided as per the current technology. A third pipe conduit 12 carries the working medium back to the compressor 3 at the suction side.

During the heating operation, which means that the valve 4 has been switched over, the compressor 3 delivers the working medium in the direction of the arrow 14 through a fourth pipe conduit 15 directly to a heat exchanger 10, which is attached to the vehicle body 7; this heat exchanger can be identical with the heat exchanger 10, as mentioned earlier. During working, an expansion of the working medium takes place in this fourth pipe conduit 15 also so that in the pressure-enthalpy diagram, a triangle shaped working diagram is generated, corresponding to a so called triangle process. A further expansion valve 16 is used here as per the current technology.

To ensure that the vibrations of the reciprocating engine 2 as well as the reciprocating compressor 3, which acts on, for example, the Z-crank principle and the pressure pulsations of the working medium of the air conditioning system do not propagate up to the heat exchangers 8 and 10 and to the vehicle body 7 and consequently up to the passenger chamber of the vehicle through the first, third and fourth pipe conduits 6, 12 and 15, a fibre reinforced rubber hose 17 and 18 is added respectively to the pipe conduits 6, 12, 15 of the popular air conditioning system 1, as is illustrated in FIG. 2, and these are connected in a leak-proof manner to the otherwise metallic pipe conduits 23 to 26 through tube collars 19 to 22, which are force fitted. These pipe conduits 6, 12 are connected in a detachable manner to the compressor 3 on one side and to any of the heat exchangers 8, 10 on the other through pipe coupling elements 27 to 30 respectively at their ends.

After mounting of the engine 2 in the engine compartment 31, as one of the connection coupling 29 is no more accessible, a short pipe piece 32 leads to an assembly-friendly position, where one more detachable connection coupling 33 is provided. The pipe section 6 on the pressure side on the contrary, due to the flexibility of the rubber hose 17, allows itself to be bent side-wise away to a free position for mounting or de-mounting of the engine 2.

In an embodiment as per the invention and hence a completely metallic configuration, made of, for example, an aluminium alloy, FIG. 3 illustrates the running pipe conduits 6′, 12′ between the compressor 3 and a heat exchanger 8, 10 of preferably a CO₂—ducting system. Their comparatively smaller outer diameters of less than 13 mm on the suction side (12′) and less than 11 mm on the pressure side (6′), together with at least one pipe curvature 35, 36, lead to a sufficient amount of yield in the pipes 6′, 12′—despite a high proof pressure strength of, for example, 500 bar—which prevents transmission of vibrations from the engine 2 to the vehicle body 7. These pipe curvatures 35, 36 are preferably provided additionally as damping curvatures to at least one of the pipe curvatures 37 to 40, which are dictated by the installation geometry of the ducting system.

For simplifying work in the engine compartment 31, including mounting and de-mounting of engine 2, an additional, easily detachable pipe joint 46 and 47 is provided in each of the pipe conduits 6′ and 12′ at a large distance from the pipe coupling elements 42 to 45 at their ends; these pipe joints, including their sealing rings (not shown), are likewise completely made of metal and hence are diffusion proof.

In the illustration in FIG. 4, a configuration of the second pipe conduit (9′) as per the invention and its configuration (9) as per the current state of technology are shown side by side. Since expansion of the working medium of the air conditioning system is to take place in this second pipe conduit 9, which is connected to either of the heat exchangers 8, 10 through the coupling elements 48′, 49′ or 48, 49 at their ends respectively, an expansion valve 50 is provided in this as per the current state of technology. Besides this, to the second pipe conduit 9, a rubber hose 51 is also assembled, which, through its flexibility, makes its installation in the engine compartment 31 easier and also contributes towards damping of vibrations.

Based on a preferred embodiment of the invention, this second pipe conduit, in which a throttling of the flow of the working medium of the air conditioning system is intended in the system of working, is made as a thin pipe 9′ with a capillary tube like small inside diameter, which is suitable for throttling of the working medium; an expansion valve 50 becomes redundant in that case. The outer diameter of this pipe conduit 9′, which is suitable for throttling, can thus be considerably smaller than that of the first and second pipe conduits 6 and 12 or 6′ and 12′ respectively, lying, for example, in the range of 2 to 4 mm. Consequently, this pipe conduit 9′ is particularly flexible and can be fitted easily and in a space saving way in the engine compartment 31. The same holds true also for the pipe conduit 15, which is used in the heating operation of a CO₂ (carbon dioxide) air conditioning system 1, wherein the customary expansion valve 16 can be replaced by a completely metallic, thin pipe conduit (15′) with capillary tube-like small inside diameter.

To avoid transmission of vibrations, generated due to pressure pulsations in working medium flow of the air conditioning system 1, an additional volume can be provided further in the completely metallic pipe conduits 6′, 15′ on the pressure side or in a possibly available pipe between the compressor 3 and the switch valve 4. Such an additional volume can be realized through an enlarged pipe diameter over a definite part length or through a separate part, which is added to the pipe conduit or the pipe—the so-called muffler 52. Such an additional volume can also be integrated with the compressor 3.

To prevent blockade through contamination in the working medium of the thin pipes 9′ and 15′, which, with their capillary tube-like small inside diameters, act as expansion valves (11, 16), a filter 53 is preferably provided in the relevant ducting systems, this filter forming a structural unit with the muffler 52, for example. Further, the filter 53 can be combined with a homogenizer (not shown), by which, the detrimental large gas cavities in the flow of the working medium can be split up in a homogeneous manner.

1. Motor vehicle with an air conditioning system (1), whose ducting (6,12,15) connects a compressor (3), which is attached to the engine (2) of the vehicle with at least one heat exchanger (8,10), which is attached to the vehicle body (7), wherein the ducting system (6,9,12,15), running in the engine compartment (31) of the vehicle, has at least one pipe curvature (37-40), which is determined by the installation geometry in the vehicle space, at least one part of the pipe conduits (6,9,12,15) of the air conditioning system is made of metallic substance and medium for vibration damping is provided to avoid transmission of vibrations from the compressor (3) to the vehicle body (7), characterized in that at least one pipe conduit (6′, 12′, 15′), which is connected on one side to the compressor (3) and to a heat exchanger (8, 10), which is attached to the vehicle body (7) on the other, is made entirely of metallic substance, inclusive of its pipe couplings (42-45), and has an outside diameter of less than 13 mm.

2. Motor vehicle according to claim 1, characterized in that in at least one pipe conduit (6′, 12′, 15′), which is entirely made of metal, at least one damping curvature (35, 36) is additionally provided to at least one pipe curvature (37-40), which is determined by the installation geometry in the engine compartment.

3. Motor vehicle according to claim 1, characterized in that one pipe conduit (9′, 15′), in which a throttling of flow of the working medium of the air conditioning system (1) is to be provided in its functioning, is made as a thin pipe conduit (9′, 15′) with a capillary tube-like small inside diameter, which is suitable for throttling of flow.

4. Motor vehicle according to claim 1, characterized in that the working medium of the air conditioning system is CO_{—}2 (carbon dioxide) and, in relation to the compressor (3), the outside diameter of its pipe conduits is smaller than 11 mm on the pressure side and smaller than 13 mm on the suction side.

5. Motor vehicle according to claim 4, characterized in that an area of the CO_{—}2-ducting of the air conditioning system (1), in which a throttling of flow of its working medium CO_{—}2 is to be provided, is made as thin pipe conduits (9′, 15′) with a capillary tube like inside diameter of less than 2 mm and an outside diameter in the range of 2 to 4 mm.

6. Motor vehicle according to claim 5, characterized in that a filter (53) is added in flow direction in the ducting before the pipe conduit (9′, 15′) with capillary tube-like inside diameter.

7. Motor vehicle according to claim 1, characterized in that at least one fully metallic pipe conduit (6′, 12′) of the ducting has an additional pipe coupling (46, 47) at a distance away from its connection couplings (42-45) for the compressor (3) and for the heat exchanger (8,10).

8. Motor vehicle according to claim 1, characterized in that in a pipe conduit (6′), leading from the compressor (3) to a heat exchanger (8) on the pressure side of the ducting of the air conditioning system (1), an enlargement of cross section (52) is provided for damping the pressure impulses in the working medium flow.

9. Motor vehicle according to claim 9, charcterized in that the enlargement of cross section of the ducting in a pipe conduit, which is intended for damping the pressure impulses, is provided in the form of muffler like pipe enlargement.

10. Motor vehicle according to claim 1, characterized in that the pipe conduits (6, 12, 15) of the ducting of the air conditioning system (1), including their pipe couplings (42-49) and their sealing elements, are made from diffusion-proof metal.

11. Motor vehicle according to claim 2, characterized in that one pipe conduit (9′, 15′), in which a throttling of flow of the working medium of the air conditioning system (1) is to be provided in its functioning, is made as a thin pipe conduit (9′, 15′) with a capillary tube-like small inside diameter, which is suitable for throttling of flow.

12. Motor vehicle according to claim 3, characterized in that the working medium of the air conditioning system is CO₂ (carbon dioxide) and, in relation to the compressor (3), the outside diameter of its pipe conduits is smaller than 11 mm on the pressure side and smaller than 13 mm on the suction side.

13. Motor vehicle according to claim 3, characterized in that an area of the CO₂-ducting of the air conditioning system (1), in which a throttling of flow of its working medium CO₂ is to be provided, is made as thin pipe conduits (9′, 15′) with a capillary tube like inside diameter of less than 2 mm and an outside diameter in the range of 2 to 4 mm.

14. Motor vehicle according to claim 11, characterized in that at least one fully metallic pipe conduit (6′, 12′) of the ducting has an additional pipe coupling (46, 47) at a distance away from its connection couplings (42-45) for the compressor (3) and for the heat exchanger (8,10).

15. Motor vehicle according to claim 2, characterized in that at least one fully metallic pipe conduit (6′, 12′) of the ducting has an additional pipe coupling (46, 47) at a distance away from its connection couplings (42-45) for the compressor (3) and for the heat exchanger (8,10).

16. Motor vehicle according to claim 2, characterized in that in a pipe conduit (6′), leading from the compressor (3) to a heat exchanger (8) on the pressure side of the ducting of the air conditioning system (1), an enlargement of cross section (52) is provided for damping the pressure impulses in the working medium flow.

17. Motor vehicle according to claim 3, characterized in that in a pipe conduit (6′), leading from the compressor (3) to a heat exchanger (8) on the pressure side of the ducting of the air conditioning system (1), an enlargement of cross section (52) is provided for damping the pressure impulses in the working medium flow.
